(19) United States
(12) Patent Application Publication
(10) Pub. No.: US 2025/0253087 A1
(43) Pub. Date: Aug. 7, 2025

(54) DIFFERENTIAL MODE INDUCTOR FOR HIGH POWER AEROSPACE FILTERING APPLICATIONS

(71) Applicant: Hamilton Sundstrand Corporation, Charlotte, NC (US)

(72) Inventor: Michael Genovese, Rockton, IL (US)

(21) Appl. No.: 18/434,200

(22) Filed: Feb. 6, 2024

(51) Int. Cl. H01F 27/26; H01F 27/28; H01F 27/30; H01F 27/32

(52) U.S. Cl. CPC H01F 27/26; H01F 27/28; H01F 27/2823; H01F 27/306; H01F 27/325

(57) ABSTRACT

A differential mode inductor includes a core and a winding assembly. An outer core ring stack includes a stack of outer laminated sheets defining an upper ring surface and a lower ring surface. Each of the upper and lower ring surfaces extend from an outer ring surface to an inner ring surface which surrounds a core central opening in which a center core leg stack is disposed. The center core leg stack includes a stack of center laminated sheets. Each center laminated sheet includes a center core leg. The center core leg stack is separated from the outer core ring stack by a distance to define a core gap region configured to store magnetic energy resulting from the magnetic field. A winding assembly is disposed in the core central opening and includes a plurality of coil windings configured to produce a magnetic field in response to electrical current flowing therethrough.

### BACKGROUND

The embodiments are generally related to electrical filtering devices implemented in high-power aerospace applications, and more particularly, a differential mode inductor.

Differential mode (DM) inductors are used in a variety of different filtering topologies typically in combination with capacitors such as a 2nd order ‘LC’ Filter. The function of the inductor is to store and release energy within a magnetic field effectively impeding high frequency current flow in the process. These magnetic fields are stored within non-magnetic gaps within the inductor most notably the core gap within the Magnetic Path Length (MPL).

### BRIEF DESCRIPTION

A differential mode inductor includes a core and a winding. The core includes an outer core ring stack and a center core leg stack. The outer core ring stack includes a stack of outer laminated sheets defining an upper ring surface and a lower ring surface. Each of the upper and lower ring surfaces extend from an outer ring surface to an inner ring surface which surrounds a core central opening to define an inner core diameter. The center core leg stack is disposed in the core central opening and includes a stack of center laminated sheets. Each center laminated sheet includes a center core leg extending between an opposing pair of ends. The center core leg stack is separated from the outer core ring stack by a distance to define a core gap region. The winding assembly is disposed in the core central opening. The winding assembly includes a plurality of coil windings configured to produce a magnetic field in response to electrical current flowing therethrough. The core gap region is configured to store magnetic energy resulting from the magnetic field.

In addition to one or more of the features described above, or as an alternative to any of the foregoing embodiments, the outer laminated sheets and the center laminated sheets comprise a magnetic material.

In addition to one or more of the features described above, or as an alternative to any of the foregoing embodiments, each of the outer laminated sheets has a toroidal profile defined by an outer ring surface and an inner ring surface.

In addition to one or more of the features described above, or as an alternative to any of the foregoing embodiments, the outer core ring stack includes one or more mounting alignment holes extending from the upper ring surface through the outer core ring stack to the bottom ring surface.

In addition to one or more of the features described above, or as an alternative to any of the foregoing embodiments, the opposing ends have a flared shape to define a pair of flared ends, and wherein each of the center laminated sheets includes a center core leg extending between the pair of flared ends.

In addition to one or more of the features described above, or as an alternative to any of the foregoing embodiments, each of the flared ends includes opposing tooth-shaped corners.

In addition to one or more of the features described above, or as an alternative to any of the foregoing embodiments, the tooth-shaped corners extend from the center core leg toward a concave portion of the flared end at an angle.

In addition to one or more of the features described above, or as an alternative to any of the foregoing embodiments, the winding assembly comprises a bobbin coupled to center core leg stack, the bobbin configured to support the coil windings.

In addition to one or more of the features described above, or as an alternative to any of the foregoing embodiments, the bobbin comprise a bobbin hub extending about a center axis and surrounding the center core leg of the center laminated sheets, wherein coil windings wrap around the bobbin hub to establish at least one winding layer.

In addition to one or more of the features described above, or as an alternative to any of the foregoing embodiments, each coil winding comprises a metal material.

In addition to one or more of the features described above, or as an alternative to any of the foregoing embodiments, each coil winding is formed as a single wire.

In addition to one or more of the features described above, or as an alternative to any of the foregoing embodiments, each coil winding includes a plurality of individual wire strands.

In addition to one or more of the features described above, or as an alternative to any of the foregoing embodiments, wherein each coil winding is formed as an electrically conductive foil.

In addition to one or more of the features described above, or as an alternative to any of the foregoing embodiments, the bobbin comprises an electrical insulating material.

In addition to one or more of the features described above, or as an alternative to any of the foregoing embodiments, the center axis divides the core into a first core region and a second core region opposite the first core portion.

In addition to one or more of the features described above, or as an alternative to any of the foregoing embodiments, a first portion of the outer core ring stack and the core leg stack located in the first core region establishes a first magnetic flux path and a second portion of the outer core ring stack and the center core leg stack located in the second core region establishes a second magnetic flux path that is independent and separated from the first magnetic flux path.

In addition to one or more of the features described above, or as an alternative to any of the foregoing embodiments, at least one of the distances of the core gap region and the angle of the tooth-shaped corners sets a first direction of the first magnetic flux path and a second direction of the second magnetic flux path so as to achieve a target inductance and flux density operating point.

In addition to one or more of the features described above, or as an alternative to any of the foregoing embodiments, each of the coil windings are covered with an insulative coating, and wherein the coil windings are wrapped directly around the center core leg.

### BRIEF DESCRIPTION OF THE DRAWINGS

The following descriptions should not be considered limiting in any way. With reference to the accompanying drawings, like elements are numbered alike:

FIG. 1A depicts a top view of a differential mode inductor according to a non-limiting embodiment of the present disclosure;

FIG. 1B is a cross-sectional view of the differential mode inductor shown in FIG. 1A taken along line A-A;

FIG. 2 illustrates a simulation of the magnetic flux density (also referred to as the “B-Field”) produced by the differential mode inductor according to a non-limiting embodiment of the present disclosure; and

FIG. 3 illustrates a simulation of the magnetic field intensity (also referred to as the “H-Field”) produced by the differential mode inductor according to a non-limiting embodiment of the present disclosure.

### DETAILED DESCRIPTION

A detailed description of one or more embodiments of the disclosed apparatus and method are presented herein by way of exemplification and not limitation with reference to the Figures.

When energy levels stored in a differential inductor become very large, the core gap tends to become proportionally large which can lead to extensive fringing flux when a discrete gap magnetic structure is employed. Managing this fringing flux is crucial to ensure it does not penetrate nearby conductors creating excess loss or spread uncontrollably altering the desired inductance and/or causing Electro-Magnetic Interference (EMI) issues for the greater circuit/Line-Replaceable Unit (LRU). When an inductor geometry is chosen to minimize the size and weight of the device for aerospace applications it can lead to a structure that is difficult to produce which restricts the supply base and leads to increased costs.

Current state-of the art differential inductors are implemented using a multi-sector toroid in which discrete gaps used for energy storage are distributed throughout the core. This design requires the manufacturer to cut a tape-wound toroid core into eight (8) sectors and then replace the cut widths with insulation and adhesive to rejoin the structure. As a result, each core produced must be tuned to achieve the specified magnetic parameters which is a specialized, time-consuming and consequentially, expensive process.

Various non-limiting embodiment of the present disclosure provides a differential mode (DM) inductor that utilizes a core formed of stacked, magnetic lamination sheets, which can be fabricated using various fabrication methods such as, for example, die-stamping, laser-cutting, etc. The material forming the lamination sheets makes it possible to achieve any geometry, which allows for the magnetic gap region to be shaped to control the flux path hence achieving the desired inductance and flux density (i.e., “the B-Field”) operation point for a given magnetic field intensity (i.e., the “H-field”) drive level.

The differential inductor provided by one or more non-limiting embodiments reduces the costs to manufacture the core, while also allowing for inductance and flux density operation point tuning by adding or subtracting lamination sheets from the core stack. The differential inductor can also be constructed with a two-piece core that defines a split flux path extending between opposing tooth-shaped ends that are surrounded by a corresponding outer ring. The split flux path allows for mounting/alignment hole regions outside of high magnitude flux areas, while the tooth-shaped ends and the outer ring radius can be specifically designed and shaped to direct the fringing flux along a targeted path. The two-piece core structure also allows the inductor coil to be wound separately via bobbin winding operation as opposed to tunnel or toroidal winding operations, while the outer core ring can serve as a low reluctance path shielding the device and a packaging case/can. Separate top and bottom metal cans can also be added to form a complete shield.

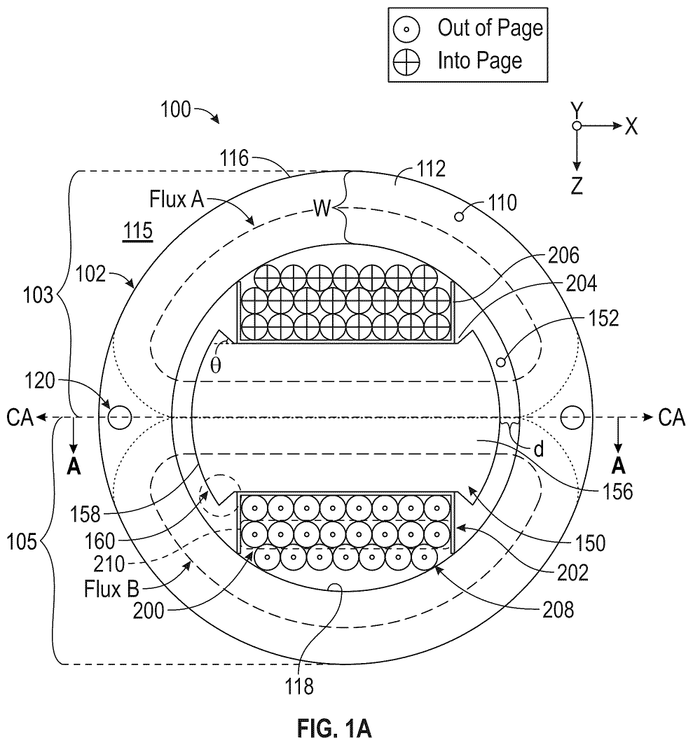

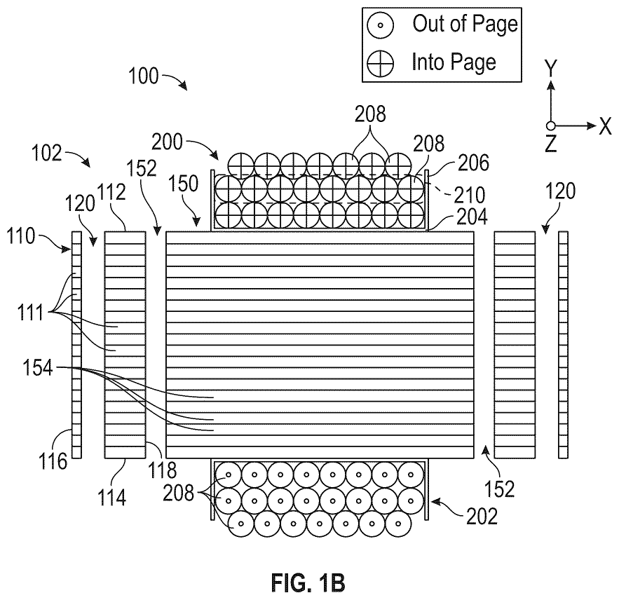

Turning now to FIGS. 1A and 1B, a differential mode inductor 100 is illustrated according to a non-limiting embodiment of the present disclosure. The differential mode inductor 100 includes a core 102 and a winding assembly 200. The core 102 includes an outer core ring stack 110 and a center core leg stack 150. The outer core ring stack 110 extends along a first axis (e.g., Y-axis) to define a height, and includes an upper ring surface 112 and a lower ring surface 114. Each of the upper ring surface 112 and a lower ring surface 114 extends along a plane (e.g., X-Z plane) orthogonal to the first axis to define a width (W) of the outer core ring stack 110.

The outer core ring stack 110 includes a stack of outer laminated sheets 111. Each of the outer laminated sheets 111 is formed from a magnetic material and has an toroidal profile. The stack outer laminated sheets 111 define an outer ring surface 116 and an inner ring surface 118. The magnetic material of the outer laminated sheets 111 includes, but is not limited to, non-grain oriented electrical steel (NGOES), silicone steel, electrical iron, nickel-iron alloys. According to a non-limiting embodiment, each of the outer laminated sheets 111 has a thickness (e.g., extending in along the Y-axis) ranging from 0.002 inches to 0.020 inches, and a width (e.g., extending along the X-axis) ranging from 0.25 inches to 2.50 inches. Although twenty (20) laminated sheets 111 are shown, it should be appreciated that more or less sheets can be included in the stack without departing from the scope of the invention.

In one or more non-limiting embodiments, the outer core ring stack 110 includes one or more mounting alignment holes 120, which extend from the upper ring surface 112 through the outer core ring stack 110 to the bottom ring surface 114. The region at which the mounting alignment holes 120 are located can be is determined by the width W where the greater W the more area for the mounting alignment hole and vice versa. The mounting alignment holes 120 can receive a mounting assembly (e.g., screw, bolt and nut, etc.) fitted therethrough to fix the differential mode inductor 100 in place. The mounting alignment holes 120 can facilitate alignment of the laminations 154 forming the core leg stack 150 during manufacturing (alignment fixture). Although the mounting holes 120 are shown having a circular profile, it should be appreciated that the holes 120 can have any type of profile without departing from the scope of the present disclosure.

The core leg stack 150 is disposed in the core central opening 115 and is separated from the outer core ring stack 110 by a distance (d) to define a core gap region 152. The core gap region can store magnetic energy produced by a magnetic field as described in greater detail below.

The core leg stack 150 includes a stack of center laminated sheets 154. Each of the center laminated sheets 154 extend along the second axis (e.g., Y-axis) to define a height of the core leg stack 150. Each of the center laminated sheet 154 is formed from magnetic material and has a thickness (e.g., extending in along the X-axis) ranging from 0.002 inches to 0.020 inches. According to a non-limiting embodiment, the number of center laminated sheets 154 equals the number of outer laminated sheets 111 and can be of the same thickness. In this manner, the fringing flux in the Y-axis direction and resulting eddy-current formation can be limited. The magnetic material of the center laminated sheets 154 includes, but is not limited to, grain oriented electrical steel (GOES), silicone steel, electrical iron, nickel-iron alloy. Although twenty (20) laminated sheets 154 are shown, it should be appreciated that more or less sheets can be included in the stack without departing from the scope of the invention.

The center laminated sheets 154 each include a center core leg 156 extending between an opposing pair of flared ends 158. Each flared end 158 includes opposing tooth-shaped corners 160 extending from the center core leg 156 to the flared end 158 at an angle (θ). For a given stack height and magnetomotive force (MMF), increasing the angle (θ) increases (e.g., toward the bobbin flanges 206), the volume of the gap region resulting in an increase in energy-storage due to an increase in inductance. Accordingly, the angle (θ) can be set in combination with the gap distance (d) to produce a target inductance. In addition, the shape of flared end 158 can further control the fringing flux and flux distribution (causes varying flux densities in the local region) but the effect on the total device flux and energy storage will be geometry specific because each could increase or decrease depending upon flared end shape.

The winding assembly 200 is disposed in the core central opening 115. The winding assembly 200 includes a bobbin 202 having a bobbin hub 204 that extends about a center axis (CA). The bobbin 202 is formed from a dielectric material or insulative material including, but not limited to, nylon, polybutelene terephthalate (PBT), polyethylene terephthalate (PET), polyphenylene sulfide (PPS), liquid crystal polymer (LCP), polyester, phenolic and diallyl phthalate (DAP), all of which could be implemented with or without reinforcing materials added such as glass fibers. The bobbin 202 surrounds the center core leg 156 of the center laminated sheets 154, and extends between an opposing pair bobbin flanges 206. The bobbin flanges 206 assist in containing and supporting the coil windings 208 in place.

In some non-limiting embodiments, the bobbin 202 can be omitted, and the coils 208 themselves galvanically isolated from the material core leg stack 150. For example, the galvanic isolation can be achieved by covering the coils 208 with an insulative coating and then wrapping the coils 208 directly around the core leg stack 150.

Coil windings 208 are wrapped around the bobbin hub 204 to establish at least one winding layer 210. Each coil winding 208 is formed from a metal material (e.g., copper) having various profiles or cross-sectional shapes. The profiles or cross-sectional shapes of the coil windings 208 include, but are not limited to, a circular profile, a square profile, a rectangular profile, a hexagonal profile, and flat profile. Each of the coil windings 208 may be formed as a single wire or may be formed as a stranded or braided coil including several individual wires. In some non-limiting embodiments, each coil windings 208 can be formed as an electrically conductive foil, which can wrap around the core leg stack 150 to define one or more foil layers.

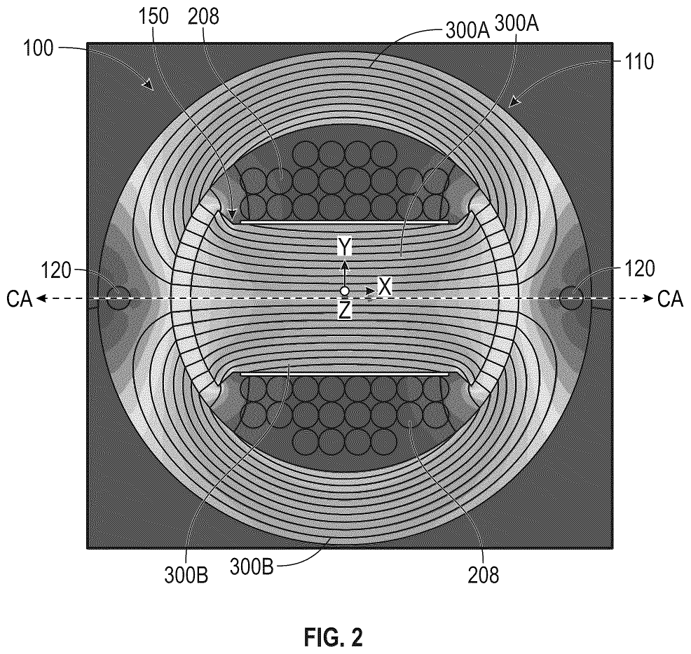

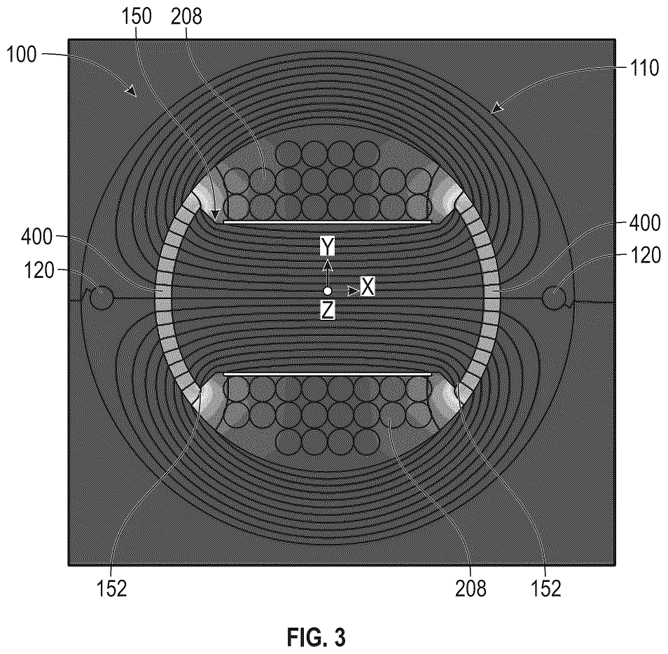

The coil windings 208 conduct electrical current flow therethrough, which induces a magnetic field. The magnetic field produces magnetic flux 300A and 300B, which flow along their dedicated flux paths A and B, respectively (See FIG. 2). The contribution of the magnetic field and the magnetic flux 300A and 300B results in magnetic energy 400, which can be stored in the core gap region 152 (See FIG. 3). The center axis (CA) extending through the differential mode inductor 100 effectively divides the core 102 into a first core region 103 and a second core region 105 opposite the first core portion, which establishes a split flux path. A first portion of the outer core ring stack 110 and the core leg stack 150 located in the first core region 103 establishes a first magnetic flux path (A) and a second portion of the outer core ring stack 110 and the center core leg stack 150 located in the second core region 105 establishes a second magnetic flux path (B) that is independent and separated from the first magnetic flux path (A).

According to a non-limiting embodiment, the distance (d) of the core gap region 152 and the angle of the tooth-shaped corners 160 sets the profile of the first and second flux paths (A and B) so as to achieve a target inductance and flux density (B) operating point for a given magnetomotive force (MMF). For example, increasing the distance (d) of the core gap region 152 will reduce the inductance provided by the differential mode inductor 100, while increasing its capacity to store magnetic energy in the core gap region 152 before magnetic saturation of the core material is realized. The distance (d) of the gap 152 and/or the shape of the flared ends 158 can be designed to set a target path of the first and second flux paths (A and B) in a manner that directs the flux away from targeted portions of the coil windings 208 and reduces fringing flux. The direction of the magnetic flux path can be set so that the mounting alignment holes 120 are formed in a region of the outer core ring stack 110 that will avoid interference with the magnetic flux flow (see FIG. 3).

In addition, the number of outer laminated sheets 111 and center laminated sheets 154 can be varied (e.g., added or removed) during manufacturing to further tune the overall inductance and flux density operating point of the differential mode inductor 100. For example, adding outer laminated sheets 111 and center laminated sheets 154 to the stacks increases the overall height of the outer core ring stack 110 and the center core leg stack 150 (e.g., increases the cross-sectional area of the core 102), which in turn decreases the magnetic flux density but increases the inductance produced by the differential mode inductor 100 for a given magnetomotive force (MMF).

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A differential mode inductor, comprising:
a core comprising:
an outer core ring stack including a stack of outer laminated sheets defining an upper ring surface and a lower ring surface, each of the upper and lower ring surfaces extending from an outer ring surface to an inner ring surface which surrounds a core central opening;
a center core leg stack disposed in the core central opening, the center core leg stack including a stack of center laminated sheets, each center laminated sheet including a center core leg extending between an opposing pair of ends, the center core leg stack separated from the outer core ring stack by a distance to define a core gap region; and
a winding assembly disposed in the core central opening, the winding assembly including a plurality of coil windings configured to produce a magnetic field in response to electrical current flowing therethrough,
wherein the core gap region is configured to store magnetic energy resulting from the magnetic field.

2. The differential mode inductor of claim 1, wherein the outer laminated sheets and the center laminated sheets comprise a magnetic material.

3. The differential mode inductor of claim 1, wherein each of the outer laminated sheets has a toroidal profile defined by an outer ring surface and an inner ring surface.

4. The differential mode inductor of claim 3, wherein the outer core ring stack includes one or more mounting alignment holes extending from the upper ring surface through the outer core ring stack to the bottom ring surface.

5. The differential mode inductor of claim 3, wherein the opposing ends have a flared shape to define a pair of flared ends, and wherein each of the center laminated sheets includes a center core leg extending between the pair of flared ends.

6. The differential mode inductor of claim 5, wherein each of the flared ends includes opposing tooth-shaped corners.

7. The differential mode inductor of claim 6, wherein the tooth-shaped corners extend from the center core leg toward a concave portion of the flared end at a set angle.

8. The differential mode inductor of claim 1, wherein the winding assembly comprises a bobbin coupled to the center core leg stack, the bobbin configured to support the coil windings.

9. The differential mode inductor of claim 8, wherein the bobbin comprises a bobbin hub extending about a center axis and surrounding the center core leg of the center laminated sheets,
wherein coil windings wrap around the bobbin hub to establish at least one winding layer.

10. The differential mode inductor of claim 8, wherein each coil winding comprises a metal material.

11. The differential mode inductor of claim 10, wherein each coil winding is formed as a single wire.

12. The differential mode inductor of claim 10, wherein each coil winding includes a plurality of individual wire strands.

13. The differential mode inductor of claim 10, wherein each coil winding is formed as an electrically conductive foil.

14. The differential mode inductor of claim 8, wherein the bobbin comprises an electrical insulating material.

15. The differential mode inductor of claim 8, wherein the center axis divides the core into a first core region and a second core region opposite the first core portion.

16. The differential mode inductor of claim 15, wherein a first portion of the outer core ring stack and the core leg stack located in the first core region establishes a first magnetic flux path and a second portion of the outer core ring stack and the center core leg stack located in the second core region establishes a second magnetic flux path that is independent and separated from the first magnetic flux path.

17. The differential mode inductor of claim 16, wherein at least one of the distance of the core gap region and the angle of the tooth-shaped corners sets a first direction of the first magnetic flux path and a second direction of the second magnetic flux path so as to achieve a target inductance and flux density operating point.

18. The differential mode inductor of claim 16, wherein each of the coil windings are covered with an insulative coating, and wherein the coil windings are wrapped directly around the center core leg.
